(19) United States
(12) Patent Application Publication
(10) Pub. No.: US 2016/0236422 A1
(43) Pub. Date: Aug. 18, 2016

(54) DEVICE AND METHOD FOR REMOVING POWDER AND APPARATUS FOR FABRICATING THREE-DIMENSIONAL OBJECT

(71) Applicant: Shozo Sakura, Kanagawa (JP)

(72) Inventor: Shozo Sakura, Kanagawa (JP)

(73) Assignee: RICOH COMPANY, LTD., Tokyo (JP)

(21) Appl. No.: 15/011,923

(22) Filed: Feb. 1, 2016

(30) Foreign Application Priority Data
Feb. 13, 2015 (JP) 2015-026852
Jun. 24, 2015 (JP) 2015-127085

(51) Int. Cl. B29C 67/00; B08B 5/02; B22F 3/24

(52) U.S. Cl. CPC B29C 67/0096; B22F 3/24; B29C 67/0081; B08B 5/02; B29K 2103/00

(57) ABSTRACT

A powder removal device includes an air spray configured to blow an airflow including powder against a three-dimensional object including a plurality of fabrication layers, to remove unbonded powder from the three-dimensional object. Each of the plurality of fabrication layers includes bonded powder.

### CROSS-REFERENCE TO RELATED APPLICATION

This patent application is based on and claims priority pursuant to 35 U.S.C. §119(a) to Japanese Patent Application Nos. 2015-026852, filed on Feb. 13, 2015, and 2015-127085, filed on Jun. 24, 2016, in the Japan Patent Office, the entire disclosure of each of which is hereby incorporated by reference herein.

### BACKGROUND

1. Technical Field

Aspects of this disclosure relate to a device and a method for removing powder and an apparatus for fabricating a three-dimensional object.

2. Related Art

A solid (three-dimensional) fabricating apparatus uses, for example, a lamination fabrication method to fabricate a solid (three-dimensional) object. In this method, for example, a flattened metal or non-metal powder layer is formed on a fabrication stage, and fabrication liquid is discharged from a head to the powder layer on the fabrication stage to form a thin fabrication layer in which powders are bonded together. A step of forming another powder layer on the fabrication layer to reform the fabrication layer is repeated to laminate the fabrication layers one on another, thus producing a three-dimensional object.

### SUMMARY

In an aspect of the present disclosure, there is provided a powder removal device that includes an air spray configured to blow an airflow including powder against a three-dimensional object including a plurality of fabrication layers, to remove unbonded powder from the three-dimensional object. Each of the plurality of fabrication layers includes bonded powder.

In another aspect of the present disclosure, there is provided an apparatus for fabricating a three-dimensional object. The apparatus includes the powder removal device.

In still another aspect of the present disclosure, there is provided an apparatus for fabricating a three-dimensional object. The apparatus includes the powder removal device, a fabrication chamber, and a fabrication stage. The three-dimensional object is to be fabricated in the fabrication chamber. The plurality of fabrication layers are to be laminated one on another on the fabrication stage. The fabrication stage is movable upward and downward in the fabrication chamber. The powder removal device includes a post-processing space at a bottom side of the fabrication chamber. The post-processing space is communicated with the fabrication chamber. The fabrication stage is movable downward from the fabrication chamber into the post-processing space. The air spray is configured to blow the airflow including the powder against the three-dimensional object on the fabrication stage.

In still yet another aspect of the present disclosure, there is provided a method of removing powder from a three-dimensional object. The method includes blowing an airflow including the powder to the three-dimensional object including a plurality of fabrication layers to remove unbonded powder from the three-dimensional object. Each of the plurality of fabrication layers includes bonded powder.

### BRIEF DESCRIPTION OF THE SEVERAL VIEWS OF THE DRAWINGS

The aforementioned and other aspects, features, and advantages of the present disclosure would be better understood by reference to the following detailed description when considered in connection with the accompanying drawings, wherein:

FIG. 1 is a partial perspective view of a three-dimensional fabricating apparatus according to an embodiment of this disclosure;

FIG. 2 is a cross-sectional view of a fabrication section of the three-dimensional fabricating apparatus;

FIGS. 3A through 3E are schematic cross-sectional views of the fabrication section at fabrication steps;

FIG. 4 is a flow chart of an entire process of fabricating a three-dimensional object according to an embodiment of this disclosure;

FIG. 5A is an illustration of an example of three-dimensional data of a target three-dimensional object;

FIG. 5B is an illustration of a three-dimensional object taken from a fabrication chamber;

FIG. 6 is an illustration of a method of removing powder according to an embodiment of this disclosure;

FIGS. 7A and 7B are schematic views of a powder removal device according to a first embodiment of this disclosure;

FIG. 8 is a schematic view of a second embodiment of the present disclosure;

FIG. 9 is a schematic view of a third embodiment of the present disclosure;

FIG. 10 is a schematic view of a fourth embodiment of the present disclosure;

FIGS. 11A and 11B are schematic views of a fifth embodiment of the present disclosure;

FIG. 12 is a flow chart of an entire process of fabricating a three-dimensional object according to an embodiment of this disclosure;

FIG. 13 is a schematic view of a sixth embodiment of the present disclosure;

FIG. 14 is a schematic view of a seventh embodiment of the present disclosure;

FIGS. 15A and 15B are schematic views of an eighth embodiment of the present disclosure; and

FIG. 16 is a schematic view of a ninth embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

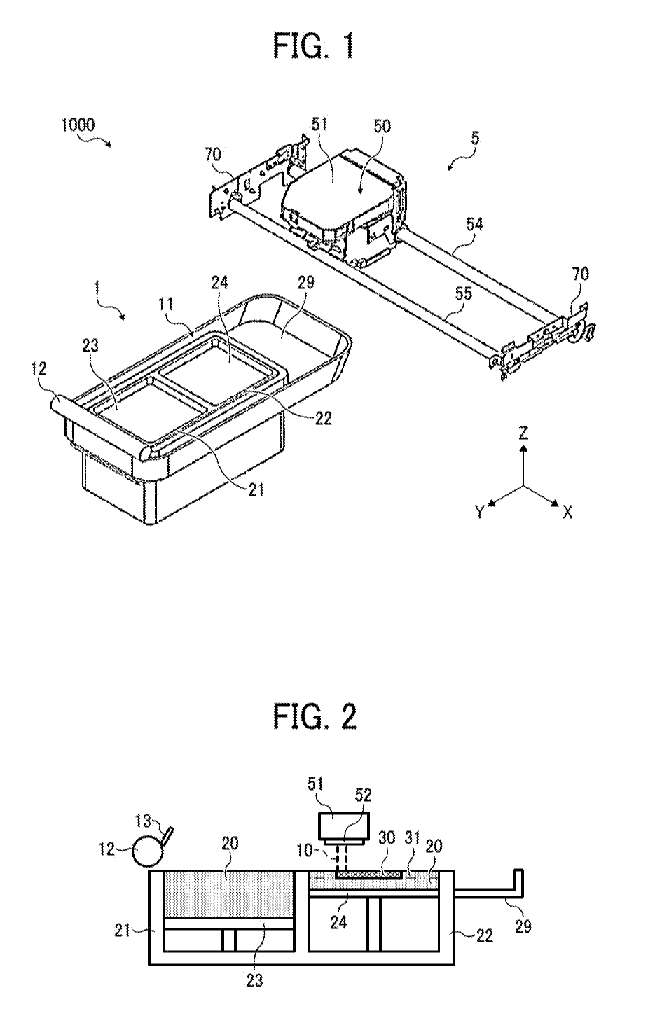

Hereinafter, embodiments of the present disclosure are described with reference to the attached drawings. First, a three-dimensional fabricating apparatus according to a first embodiment of the present disclosure is described with reference to FIGS. 1 and 2. FIG. 1 is a partial perspective view of the three-dimensional fabricating apparatus according to the first embodiment of the present disclosure. FIG. 2 is a cross-sectional view of a fabricating section of the three-dimensional fabricating apparatus. In FIG. 2, a state of the fabricating section in fabrication.

In this embodiment, a three-dimensional fabricating apparatus 1000 is a powder fabricating apparatus (also referred to as a powder fabricating apparatus). The three-dimensional fabricating apparatus 1000 includes a fabrication section 1 and a fabrication unit 5. The fabrication section 1 forms a fabrication layer 30 that is a layered fabrication object in which powders are bonded together. The fabrication unit 5 fabricates a three-dimensional object by discharging fabrication liquid 10 onto a powder layer 31 that is overlaid in layers in the fabrication section 1.

The fabrication section 1 includes a powder chamber 11 and a flattening roller 12 as a rotator that is a flattening member (recoater). Note that the flattening member may be, for example, a plate member (blade) instead of the rotator.

The powder chamber 11 includes a supply chamber 21 to supply powder 20 and a fabrication chamber 22 to fabricate an object. A bottom portion of the supply chamber 21 serves as a supply stage 23 and is movable upward and downward in a vertical direction (height direction). Similarly, a bottom portion of the fabrication chamber 22 serves as a fabrication stage 24 and is movable upward and downward in the vertical direction (height direction). A three-dimensional object is fabricated on the fabrication stage 24.

The flattening roller 12 supplies the powder 20 supplied on the supply stage 23 of the supply chamber 21, to the fabrication chamber 22 and flattens the powder 20 with the flattening roller 12 to form a powder layer 31.

With a reciprocal moving assembly, the flattening roller 12 is movable relatively reciprocally with respect to a stage surface (a surface on which powder 20 is stacked) of the fabrication stage 24 in a direction indicated by arrow Y in FIG. 2, which is a direction along the stage surface of the fabrication stage 24. When the flattening roller 12 moves, the flattening roller 12 is driven to rotate.

The fabrication unit 5 includes a liquid discharge unit 50 to discharge fabrication liquid 10 to the powder layer 31 on the fabrication stage 24.

The liquid discharge unit 50 includes a carriage 51 and one or more liquid discharge heads (hereinafter referred to as simply “head(s)”) 52 mounted on the carriage 51.

The carriage 51 is movably held with guides 54 and 55. The guides 54 and 55 are held with holders 70 at lateral ends.

A main scan moving unit including, e.g., a motor, a pulley, and a belt reciprocally moves the carriage 51 along the direction indicated by arrow X (hereinafter simply referred to as “X direction”) that is a main scanning direction.

The head 52 includes nozzle arrays, each including multiple nozzles arrayed in line, to discharge cyan fabrication liquid, magenta fabrication liquid, yellow fabrication liquid, and clear color fabrication liquid. Note that the configuration of head is not limited to the above-described configuration of the head 52 and may be any other suitable configuration.

The entire fabrication unit 5 is reciprocally movable in the Y direction perpendicular to a direction indicated by arrow X (hereinafter, “X direction”) .

The liquid discharge unit 50 is disposed to be movable upward and downward along a direction indicated by arrow Z (hereinafter, “Z direction”) together with the guides 54 and 55.

In the following, the fabrication section 1 is further described.

The powder chamber 11 has a box shape and includes two chambers, the supply chamber 21 and the fabrication chamber 22, each of which is open at the upper side thereof. The supply stage 23 and the fabrication stage 24 are arranged inside the supply chamber 21 and the fabrication chamber 22, respectively, so as to be movable upward and downward in the Z direction.

Lateral faces of the supply stage 23 are disposed to contact inner lateral faces of the supply chamber 21. Lateral faces of the fabrication stage 24 are disposed to contact inner lateral faces of the fabrication chamber 22. The upper faces of the supply stage 23 and the fabrication stage 24 are held horizontally.

A powder falling groove (powder receive portion) 29 is disposed at the periphery of the powder chamber 11 and has a recessed shape with the upper side thereof being open. A surplus of the powder 20 supplied with the flattening roller 12 in formation of a powder layer 31 falls to the powder receive portion 29.

A powder supplier is disposed above the supply chamber 21. In an initializing operation of fabrication or when the amount of powder in the supply chamber 21 decreases, the powder supplier supplies powder to the supply chamber 21. Examples of a powder transporting method for supplying powder include a screw conveyor method utilizing a screw and an air transport method utilizing air.

The flattening roller 12 transfers and supplies powder 20 from the supply chamber 21 to the fabrication chamber 22 and forms a desired thickness of powder layer 31.

The flattening roller 12 is a bar longer than an inside dimension of the fabrication chamber 22 and the supply chamber 21 (that is, a width of a portion to which powder is supplied or stored). The reciprocal moving assembly reciprocally moves the flattening roller 12 in the Y direction (a sub-scanning direction) along the stage surface.

The flattening roller 12, while being rotated, horizontally moves to pass an area above the supply chamber 21 and the fabrication chamber 22 from the outside of the supply chamber 21. Accordingly, the powder 20 is transferred and supplied onto the fabrication chamber 22, and the flattening roller 12 flattens the powder 20 while passing over the fabrication chamber 22, thus forming the powder layer 31.

A powder removal plate 13 serving as a powder remover to remove the powder 20 attached to the flattening roller 12 is disposed in contact with a circumferential surface of the flattening roller 12.

The powder removal plate 13 moves together with the flattening roller 12 in contact with the circumferential surface of the flattening roller 12. The powder removal plate 13 is arranged in a state in which the powder removal plate 13 counters the flattening roller 12 when the flattening roller 12 rotates in a direction in which the flattening roller 12 rotates to flatten the powder 20.

In this embodiment, the powder chamber 11 of the fabrication section 1 includes two chambers, i.e., the supply chamber 21 and the fabrication chamber 22. In some embodiments, a powder chamber includes only the fabrication chamber 22, and a powder supplier supplies powder to the fabrication chamber 22 and the flattening unit flattens the powder.

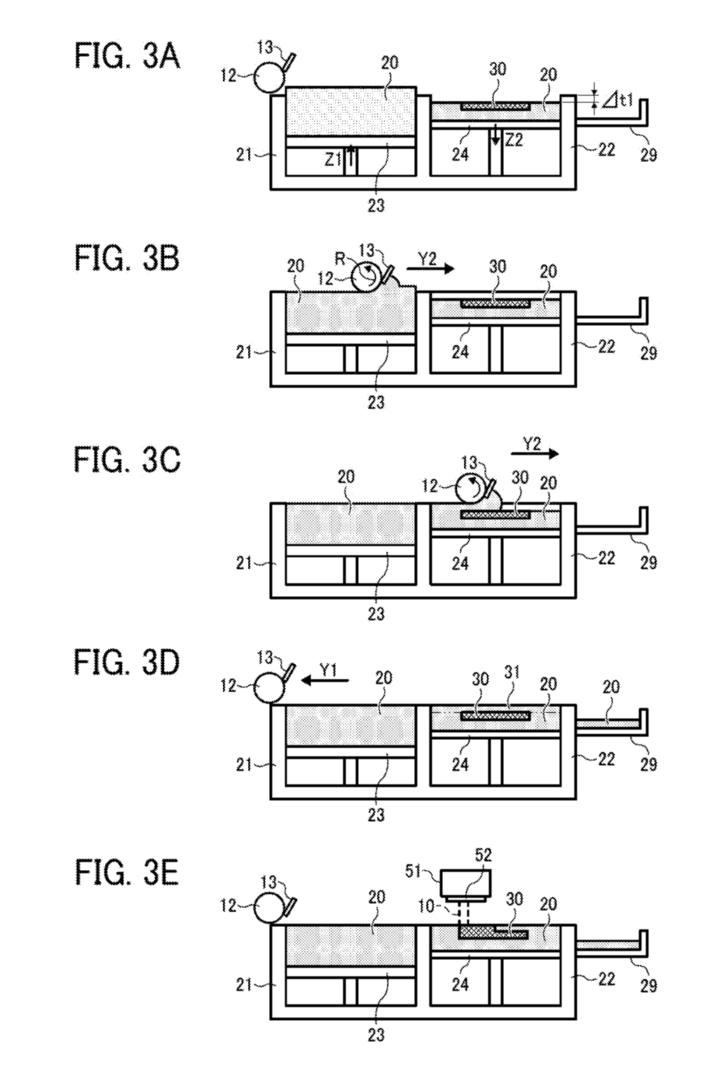

Next, a flow of fabrication is described with reference to FIGS. 3A through 3E. FIGS. 3A through 3E are schematic cross-sectional views of fabrication steps of the fabrication section.

A first fabrication layer 30 is formed on the fabrication stage 24 of the fabrication chamber 22.

When a second fabrication layer 30 is formed on the first fabrication layer 30, as illustrated in FIG. 3A, the supply stage 23 of the supply chamber 21 moves upward in a direction indicated by arrow Z1, and the fabrication stage 24 of the fabrication chamber 22 moves downward in a direction indicated by arrow Z2. At this time, a downward movement distance of the fabrication stage 24 is set so that a distance between a surface of a powder layer of the fabrication chamber 22 and a lower portion (lower tangential portion) of the flattening roller 12 is Δt1. The distance Δt1 corresponds to the thickness of the powder layer 31 to be formed next. The distance Δt1 is preferably about several tens pm to about 300 μm.

Next, as illustrated in FIG. 3B, by moving the flattening roller 12 in a direction indicated by arrow Y2 toward the fabrication chamber 22 while rotating the flattening roller 12 in a forward direction (indicated by arrow R), powder 20 upper than the level of a top face of the supply chamber 21 is transferred and supplied to the fabrication chamber 22 (powder supply).

As illustrated in FIG. 3C, the flattening roller 12 is moved in parallel to the stage surface of the fabrication stage 24 of the fabrication chamber 22. As illustrated in FIG. 3D, a powder layer 31 having a thickness of Δt1 is formed on the fabrication layer 30 of the fabrication stage 24 (flattening).

After the powder layer 31 is formed, the flattening roller 12 is moved in the direction indicated by arrow Y1 and returned to an initial position.

Here, the flattening roller 12 is movable while maintaining a constant distance between the fabrication chamber 22 and the level of the top face of the supply chamber 21. Such a configuration allows formation of a uniform thickness Δt1 of the powder layer 31 on the fabrication chamber 22 or the fabrication layer 30 already formed while transporting the powder 20 to an area above the fabrication chamber 22 with the flattening roller 12.

Then, as illustrated in FIG. 3E, droplets of fabrication liquid 10 are discharged from a head 52 of the liquid discharge unit 50 to form and laminate the next fabrication layer 30 (fabrication).

For the fabrication layer 30, for example, when the fabrication liquid 10 discharged from the head 52 is mixed with the powder 20, adhesives contained in the powder 20 dissolve and bond together. Thus, particles of the powder 20 bind together to form the fabrication layer 30.

Next, the above-described powder supply and flattening steps and the step of discharging the fabrication liquid with the head are repeated to form a new fabrication layer. At this time, a new fabrication layer and a fabrication layer below the new fabrication layer are united to form part of a three-dimensional fabrication object.

Then, the powder supply and flattening steps and the step of discharging the fabrication liquid with the head are repeated a required number of times to finish the three-dimensional fabrication object (solid fabrication object).

Next, descriptions are given of a powder material (powder) for three-dimensional fabrication and a fabrication liquid used in the three-dimensional fabricating apparatus 1000 according to this embodiment of this disclosure. It is to be noted that the powder and fabrication liquid used in a three-dimensional fabricating apparatus according to an embodiment of this disclosure is not limited to the powder and fabrication liquid described below.

The powder material for three-dimensional fabrication includes a base material and a water-soluble organic material that dissolves by action of cross-linker containing water serving as fabrication liquid and turns to be cross-linkable. The base material is coated with the water-soluble organic material at an average thickness of 5 nm to 500 nm.

For the powder material for three-dimensional fabrication, the water-soluble organic material coating the base material dissolves by action of cross-linker containing water and turns to be cross-linkable. When cross-linker containing water is applied to the water-soluble organic material, the water-soluble organic material dissolves and cross-link by action of cross-linkers contained in the cross-linker containing water.

Thus, a thin layer (powder layer) is formed with the powder material for three-dimensional fabrication. When the cross-linker containing water is discharged as the fabrication liquid 10 onto the powder layer, the dissolved water-soluble organic material cross-links in the powder layer. As a result, the powder layer is bonded and hardened, thus forming the fabrication layer 30.

At this time, the coverage of the water-soluble organic material coating the base material is 5 nm to 500 nm in average thickness. When the water-soluble organic material dissolves, only a minimum required amount of the water-soluble organic material is present around the base material. The minimum required amount of water-soluble organic material cross-links and forms a three-dimensional network. Accordingly, the powder layer is hardened at a good dimensional accuracy and strength.

Repeating the operation allows a complex three-dimensional object to be simply and effectively formed at a good dimensional accuracy without losing the shape before sintering.

### Base Material

The base material is not limited to a specific material as long as the material has a shape of powder or particle. Any powder or particulate material can be selected as the base material according to the purpose. Examples of the material include metal, ceramic, carbon, polymer, wood, and biocompatible material. From a viewpoint of obtaining a relatively high strength of three-dimensional object, for example, metal or ceramic which can be finally sintered is preferable.

Preferable examples of metal include stainless steel (SUS), iron, copper, titan, and silver. An example of SUS is SUS316L.

Examples of ceramic include metal oxide, such as silica (SiO₂), alumina (AL₂O₃), zirconia (ZrO₂), and titania (TiO₂).

Examples of carbon include graphite, graphene, carbon nanotube, carbon nanohorn, and fullerene.

An example of polymer is publicly-known water-insoluble resin.

Examples of wood include woodchip and cellulose.

Examples of biocompatible material includes polylactic acid and calcium phosphate.

Of such materials, one material can be solely used or two or more types of materials can be used together.

Note that commercially available particles or powder formed of such materials can be used as the base material. Examples of commercial products include SUS316L (PSS316L made by SANYO SPECIAL STEEL Co., Ltd), SiO₂ (Ecserica SE-15 made by Tokuyama Corporation), ZrO₂ (TZ-B53 made by Tosoh Corporation).

To enhance the compatibility with water-soluble organic material, known surface (reforming) treatment may be performed on the base material.

### Water-Soluble Organic Material

The water-soluble organic material is not limited to a specific material as long as the material dissolves in water and is cross-linkable by action of cross-linker. In other words, if it is water-soluble and water-linkable by action of cross-linker, any material can be selected according to the purpose.

Here, the water solubility of water-soluble organic material means that, when a water-soluble organic material of 1 g is mixed into water 100 g at 30° C. and stirred, not less than 90 mass percentage of the water-soluble organic material dissolves in the water.

As the water-soluble organic material, the viscosity of four mass percentage (w/w %) solution at 20° C. is preferably not greater than 40 mPa·s, more preferably 1 to 35 mPa·s, particularly more 5 to 30 mPa·s.

When the viscosity of the water-soluble organic material is greater than 40 mPa·s, the hardness of a hardened material (three-dimensional object or hardened material for sintering) of the powder material (powder layer) for three-dimensional object formed by applying cross-linker containing water to the powder material for three-dimensional fabrication may be insufficient. As a result, in post-treatment, such as sintering, and handling, the hardened material may lose the shape. In addition, the hardened material may be insufficient in dimensional accuracy.

The viscosity of the water-soluble organic material can be measured in accordance with, for example, JISK117.

### Cross-Linker Containing Water

The cross-linker containing water serving as fabrication liquid is not limited to any specific liquid as long as the liquid contains cross linker in aqueous medium, and any suitable liquid is selectable according to the purpose. The cross-linker containing water can include any other suitable component as needed in addition to the aqueous medium and the cross-linker.

As such other component, any suitable component is selectable in consideration of conditions, such as the type of an applicator of the cross-linker containing water or the frequency and amount of use. For example, when the cross-linker containing water is applied according to a liquid discharge method, a component can be selected in consideration with influences of clogging to nozzles of the liquid discharge head.

Examples of the aqueous medium include alcohol, ethanol, ether, ketone, and preferably water. The aqueous medium may be water containing a slight amount of other component, such as alcohol, than water.

Using the above-described powder material for three-dimensional object and cross-linker containing water serving as fabrication liquid reduces clogging of nozzles and enhances the durability of the liquid discharge head as compared to a configuration in which the liquid discharge head discharges binder to attach powder (base material).

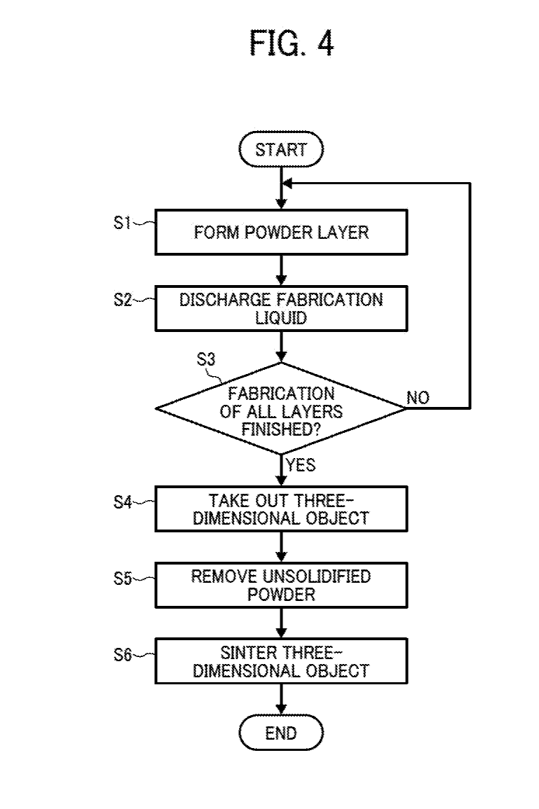

Next, an entire process of fabricating the three-dimensional object is described with reference to FIG. 4.

At S1, a powder layer 31 is formed and at S2 fabrication liquid 10 is discharged as described above. When the fabrication of all layers is completed (YES at S3), at S4 a three-dimensional object 300 is taken from the fabrication chamber 22.

After powder removal processing for removing powder 20 remaining on the three-dimensional object 300 is performed at S5, at S6 the three-dimensional object 300 is sintered to obtain a finished product.

If the three-dimensional object 300 is sintered without performing powder removal processing, unsolidified powder particles would bond together, thus forming a fabrication object having a shape differing from a target shape.

As described above, when a three-dimensional object fabricated by a powder lamination fabrication method, unbonded (unsolidified) powder remains adhered to the three-dimensional object. However, when the three-dimensional object has a complex and fine shape, unsolidified powder may not be removed from the three-dimensional object only by blowing gas.

Hence, as described below, according to at least one embodiment of the present disclosure, unbonded powder remaining on a three-dimensional object is effectively removed from the three-dimensional object.

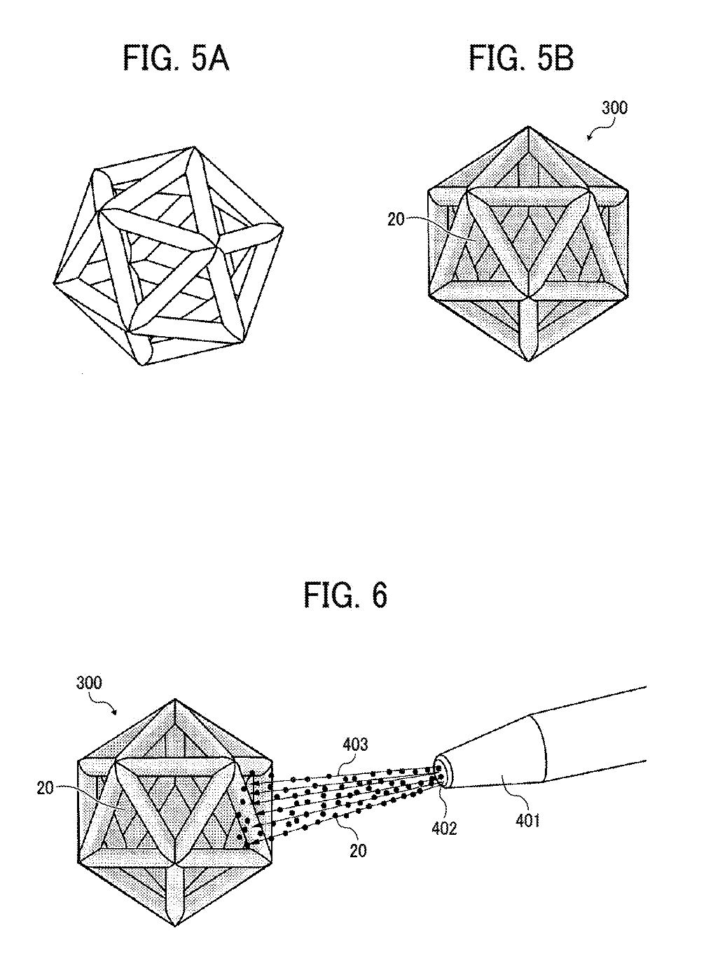

Below, a method of removing powder according to an embodiment of the present disclosure is described with reference to FIGS. 5A and 5B and 6. FIGS. 5A and 5B are illustrations of three-dimensional data of a target three-dimensional object and a three-dimensional object taken from a fabrication chamber in this embodiment. FIG. 6 is an illustration of the method of removing powder according to this embodiment.

Through fabrication of a three-dimensional object represented by three-dimensional data illustrated in FIG. 5A, a three-dimensional object 300 is fabricated in the fabrication chamber 22. As illustrated in FIG. 5B, the three-dimensional object 300 is taken from the fabrication chamber 22 with the powder 20 filling an internal space of the three-dimensional object 300, and unbonded (also referred to unsolidified) powder 20 is also adhered to the three-dimensional object 300.

As described above, unbonded powder 20 adhered to the three-dimensional object 300 is removed by sintering to turn the shape of the three-dimensional object 300 into the target shape. At this time, when the three-dimensional object 300 has a shape of including an internal space or a fine and complex shape, unbonded powder 20 may not be easily removed.

Hence, for the method of removing powder according to this embodiment, as illustrated in FIG. 6, an airflow 403 including powder 20, which is the same as the powder 20 used for fabrication of the three-dimensional object 300, is jetted from a nozzle 402 of an ejector 401 to blow the airflow 403 including the powder 20 against the three-dimensional object 300.

As described above, in this embodiment, unbonded powder 20 adhered to the three-dimensional object 300 is removed by blowing the airflow 403 including the powder 20 against the three-dimensional object 300. Such a method effectively removes unbonded powder 20 adhered to the three-dimensional object 300.

Further, in this embodiment, the powder 20 for fabrication of the three-dimensional object 300 is used for powder blown against the three-dimensional object 300. Thus, even if the three-dimensional object 300 is sintered with powder 20 blown to the three-dimensional object 300 remaining adhered to the three-dimensional object 300, the physical properties of the three-dimensional object 300 remain unchanged after sintering.

In other words, in a case in which a different type of powder from the powder used for fabrication is used in a gas blown against the three-dimensional object 300, if the three-dimensional object 300 is sintered with the blown powder remaining adhered to the three-dimensional object 300, the physical properties of the three-dimensional object 300 might be changed.

By using the powder 20 for fabrication of the three-dimensional object 300 as the powder to be blown against the three-dimensional object 300, the powder 20 having been used for powder removal can be collected and reused.

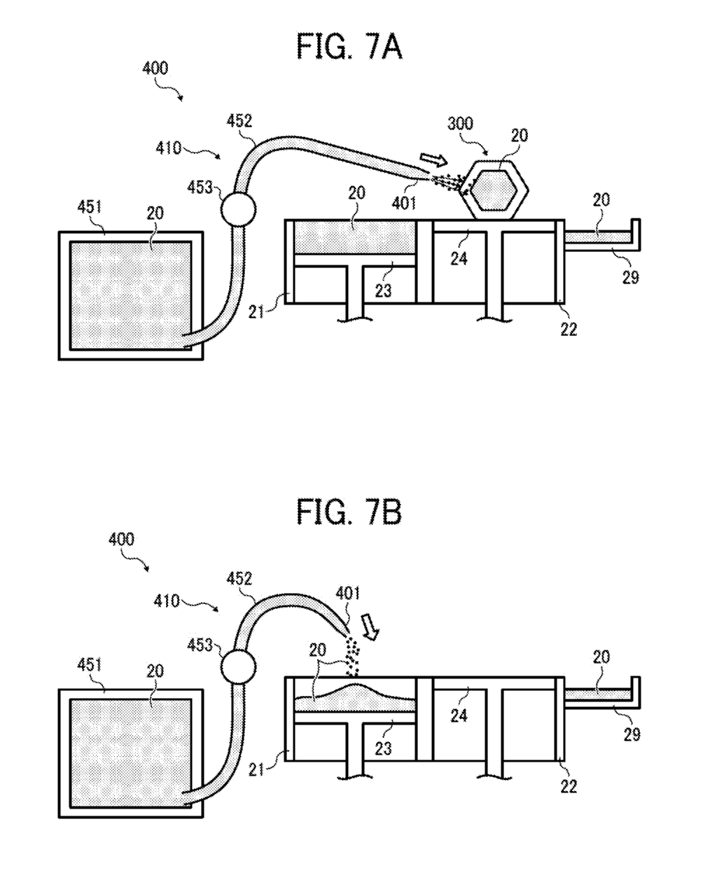

Next, a powder removal device according to a first embodiment of the present disclosure is described with reference to FIGS. 7A and 7B. FIGS. 7A and 7B are schematic views of the powder removal device according to the first embodiment. FIG. 7A is an illustration of a state of the powder removal device in which the powder removal device is in powder removal operation. FIG. 7B is an illustration of a state of the powder removal device in which powder is supplied to a supply chamber.

In FIGS. 7A and 7B, a powder removal device 400 according to this embodiment includes an air spray 410 to blow an airflow against a three-dimensional object. The air spray 410 includes, for example, an ejector 401, a powder reserve tank 451, and a powder supply passage 452. The ejector 401 jets an airflow 403 including powder 20 to a three-dimensional object 300. The powder reserve tank 451 is a reservoir to reserve the powder 20. The powder supply passage 452 as a powder supplier connects the powder reserve tank 451 to the ejector 401 to guide the powder 20 from the powder reserve tank 451 to the ejector 401.

The powder supply passage 452 includes a pump 453 as an airflow generator to generate an airflow 403 blown from the nozzle 402 of the ejector 401.

The powder supply passage 452 coupled to the ejector 401 is made of a flexible member to change a direction in which the powder 20 is blown from the ejector 401 and a position to which the powder 20 is blown from the ejector 401.

Hence, when powder is removed from the three-dimensional object 300, as illustrated in FIG. 7A, the three-dimensional object 300 is placed on the fabrication stage 24. While sucking the powder 20 of the powder reserve tank 451 by driving the pump 453, the powder removal device 400 blows the airflow 403 including the powder 20 from the nozzle 402 of the ejector 401 against the three-dimensional object 300. Thus, unbonded powder 20 adhered to the three-dimensional object 300 is removed.

By contrast, when the powder 20 is supplied to the supply chamber 21, as illustrated in FIG. 7B, the powder 20 is supplied to the supply chamber 21 with the ejector 401 removed or mounted.

Thus, powder removal from the three-dimensional object 300 is performed, and the powder 20 of the supply chamber 21 is replenished.

In such a case, the output of the pump 453 can be changed between when powder removal from the three-dimensional object 300 is performed and when the powder 20 of the supply chamber 21 is replenished.

For example, the output of the pump 453 when powder removal from the three-dimensional object 300 is performed is set to be greater than the output of the pump 453 when the powder 20 is supplied to the supply chamber 21. Accordingly, when powder removal from the three-dimensional object 300 is performed, the velocity of flow in the powder supply passage 452 is relatively fast, thus allowing effective removal of the powder 20.

Further, the powder supply passage 452 may be configured to be attachable to and detachable from the ejector 401 so that an ejector 401 to perform powder removal from the three-dimensional object 300 is replaceable with an ejector 401 to replenish the powder 20 to the supply chamber 21.

In such a case, for example, the ejector 401 to perform powder removal from the three-dimensional object 300 has a relatively small diameter of nozzle, and the ejector 401 to supply the powder 20 to the supply chamber 21 has a relatively large diameter of nozzle. Accordingly, when powder removal from the three-dimensional object 300 is performed, the velocity of flow in the powder supply passage 452 is relatively fast, thus allowing effective removal of the powder 20. Further, when the powder 20 is supplied to the supply chamber 21, such a configuration prevents the powder 20 to be jetted at an unnecessary high speed, thus reducing scattering of the powder 20.

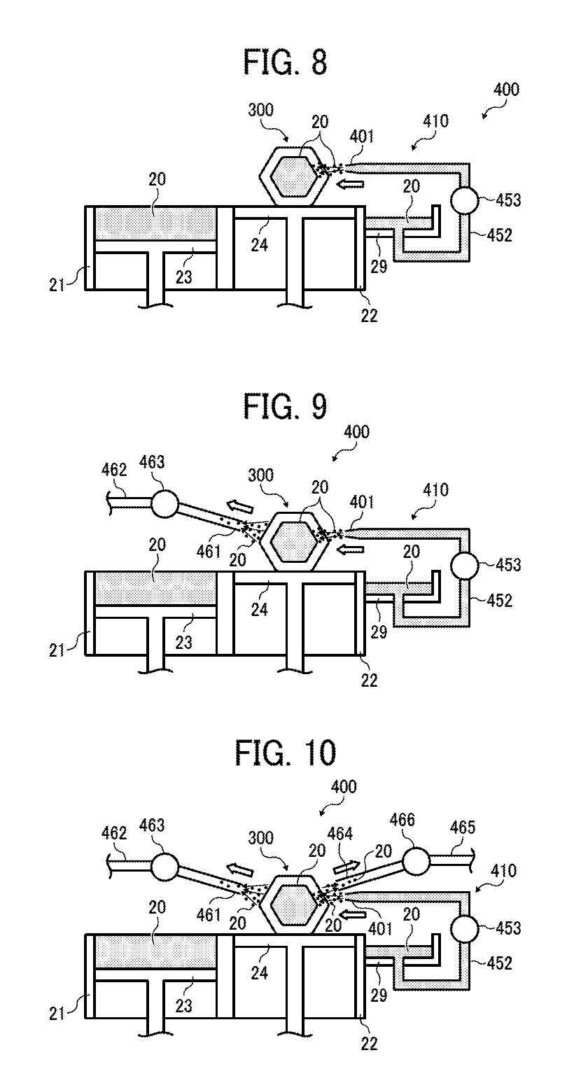

Next, a second embodiment of the present disclosure is described with reference to FIG. 8. FIG. 8 is a schematic view of the second embodiment.

In this embodiment, the powder supply passage 452 in first embodiment is coupled to a powder receive portion 29 to receive extra powder 20 generated in formation of a powder layer 31. Powder removal from the three-dimensional object 300 is performed using the extra powder 20 accumulated in the powder receive portion 29. In this embodiment, the powder receive portion 29 is also a reservoir to reserve the powder 20.

Such a configuration allows removal of unbonded powder 20 without using unused powder 20. Accordingly, for example, when processing, such as screen classification or dehumidification, is performed on already-used powder 20 or unbonded powder 20 for reuse, the steps of processing can be reduced.

Next, a third embodiment of the present disclosure is described with reference to FIG. 9. FIG. 9 is a schematic view of the third embodiment.

In this third embodiment, the powder removal device 400 according to the above-described second embodiment further includes a suction unit 461 to suck powder 20 removed from a three-dimensional object 300. The suction unit 461 is placeable at a side opposite the ejector 401 via the three-dimensional object 300, in other words, at a side opposite a side of the three-dimensional object 300 against which the airflow 403 including the powder 20 is blown when the powder 20 is removed from the three-dimensional object 300.

The suction unit 461 is coupled to one end of a powder collection passage 462, and a suction pump 463 to generate a sucking air flow is disposed at the powder collection passage 462.

Such a configuration sucks and collects, from the suction unit 461, powder 20 separated by an airflow 403 from the ejector 401 or powder 20 included in the airflow 403 when the powder 20 is removed from the three-dimensional object 300.

Thus, scattering the powder 20 can be reduced when powder removal from the three-dimensional object 300 is performed.

The other end of the powder collection passage 462 is coupled to the powder receive portion 29 or a powder reserve tank 451 described in the first embodiment, thus allowing effective circulation of the powder 20.

Next, a fourth embodiment of the present disclosure is described with reference to FIG. 10. FIG. 10 is a schematic view of the fourth embodiment.

In the fourth embodiment, the powder removal device 400 according to the above-described third embodiment further includes another suction unit 464 to suck powder 20 rebounded from a three-dimensional object 300. The suction unit 461 is placeable adjacent to the ejector 401, in other words, at the same side as the side of the three-dimensional object 300 against which the airflow 403 including the powder 20 is blown when the powder 20 is removed from the three-dimensional object 300.

The suction unit 464 is coupled to one end of a powder collection passage 465, and a suction pump 466 to generate a suction airflow is disposed at the powder collection passage 465.

Such a configuration sucks and collects, from the suction unit 464, powder 20 blown from the ejector 401 against the three-dimensional object 300 and rebounded from the three-dimensional object 300 when the powder 20 is removed from the three-dimensional object 300.

Thus, scattering the powder 20 can be reduced when powder removal from the three-dimensional object 300 is performed.

The other end of the powder collection passage 465 is coupled to the powder receive portion 29 or a powder reserve tank 451 described in first embodiment, thus allowing effective circulation of the powder 20.

The powder removal device according to any one of the above-described embodiments is configured to be part of the above-described three-dimensional fabricating apparatus. Alternatively, as a device independent of the three-dimensional fabricating apparatus, the powder removal device may be disposed in, for example, a blast case to perform powder removal.

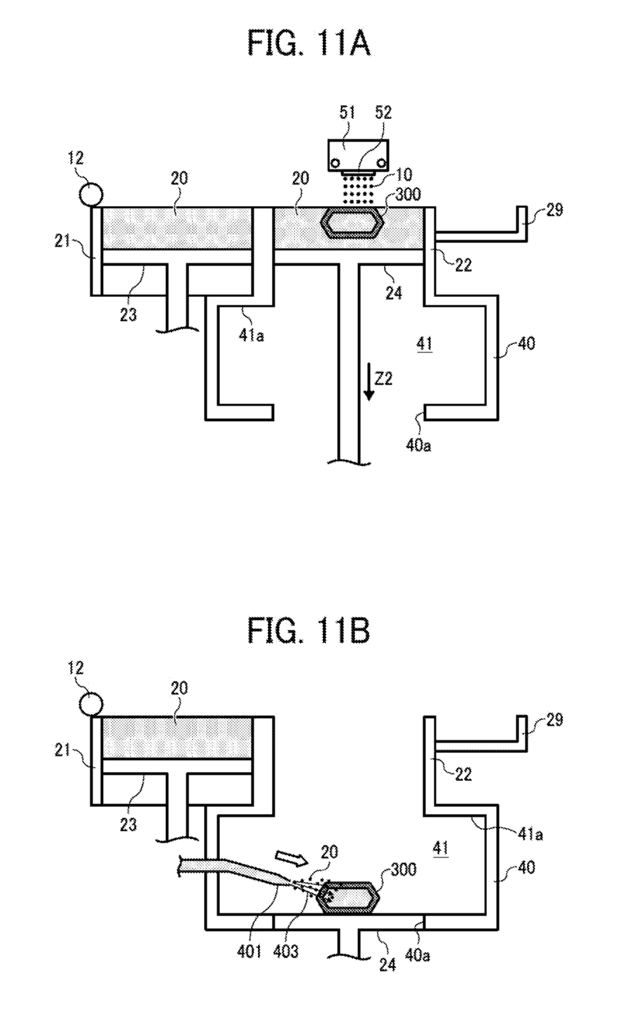

Next, a fifth embodiment of the present disclosure is described with reference to FIGS. 11A and 11B. FIGS. 11A and 11B are schematic views of the fifth embodiment.

In this embodiment, a post-processing space formation member 40 molded with the fabrication chamber 22 as a single component is disposed at a bottom side of the fabrication chamber 22 to form a post-processing space 41 connected to the interior of the fabrication chamber 22.

A fabrication stage 24 is disposed in the fabrication chamber 22 to be movable upward and downward. The fabrication stage 24 is also movable downward from the fabrication chamber 22 into the post-processing space 41 and movable within the post-processing space 41.

In this embodiment, the post-processing space formation member 40 includes a bottom mouth 40a When the fabrication stage 24 fits in the bottom mouth 40a of the post-processing space formation member 40, the post-processing space 41 becomes a substantially closed space.

In the post-processing space 41 is disposed an ejector 401 to blow an airflow 403 including powder 20 against a three-dimensional object 300.

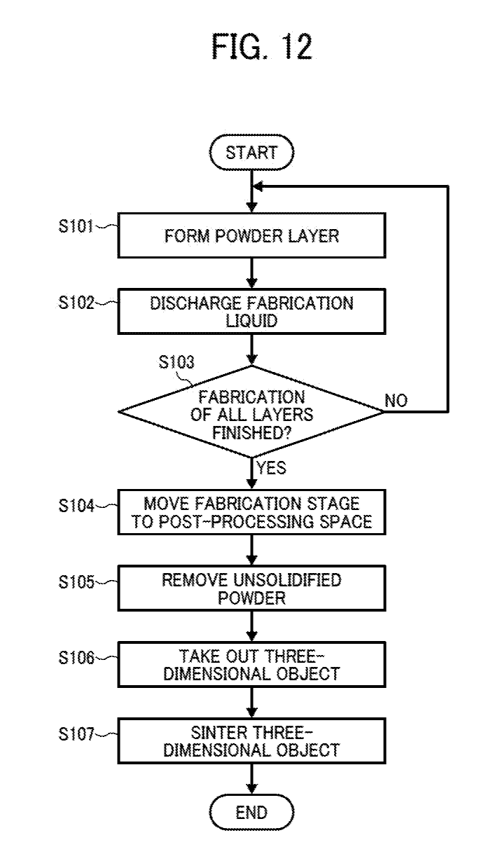

Next, an entire process of fabricating a three-dimensional object in this embodiment is described with reference to FIG. 12.

At S101, a powder layer 31 is formed and at S102 fabrication liquid 10 is discharged. When the fabrication of all layers is completed (YES at S103), at S104 the fabrication stage 24 moves from a fabrication position illustrated in FIG. 11A into the post-processing space 41 as illustrated in FIG. 11B and fits in the bottom mouth 40a of the post-processing space formation member 40.

Then, as illustrated in FIG. 11B, at S105 powder removal processing is performed to blow the airflow 403 including the powder 20 against the three-dimensional object 300 by the ejector 401 to remove unsolidified powder from the three-dimensional object 300. FIG. 11B is an illustration of a state in which, after blowing unsolidified powder 20 around the three-dimensional object 300 with the airflow 403, the powder removal device 400 blows unsolidified powder 20 in the internal space of the three-dimensional object 300. After the three-dimensional object 300 is taken from the fabrication chamber 22 at S106, at S107 the three-dimensional object 300 is sintered to obtain a finished product.

In such a configuration, after fabrication, the three-dimensional object 300 filled in unsolidified powder 20 in the fabrication chamber 22 is moved into the post-processing space 41 with downward movement of the fabrication stage 24 without scattering the powder 20 around the powder removal device 400.

Then, unsolidified powder 20 is removed from the three-dimensional object 300 within the post-processing space 41. Thus, powder removal is performed without scattering the powder 20 around the powder removal device 400

In such a case, the removal of unsolidified powder 20 may be performed by jetting an airflow including blast material other than powder 20 from the ejector 401. However, use of the powder 20 allows already-used powder to be easily reused without mixture of foreign substance.

Further, setting a larger volume of the post-processing space 41 than the volume of the fabrication chamber 22 secures good workability in removing unsolidified powder 20 and prevents powder from being discharged to the outside of the powder removal device 400 from an upper portion 41a of the post-processing space 41.

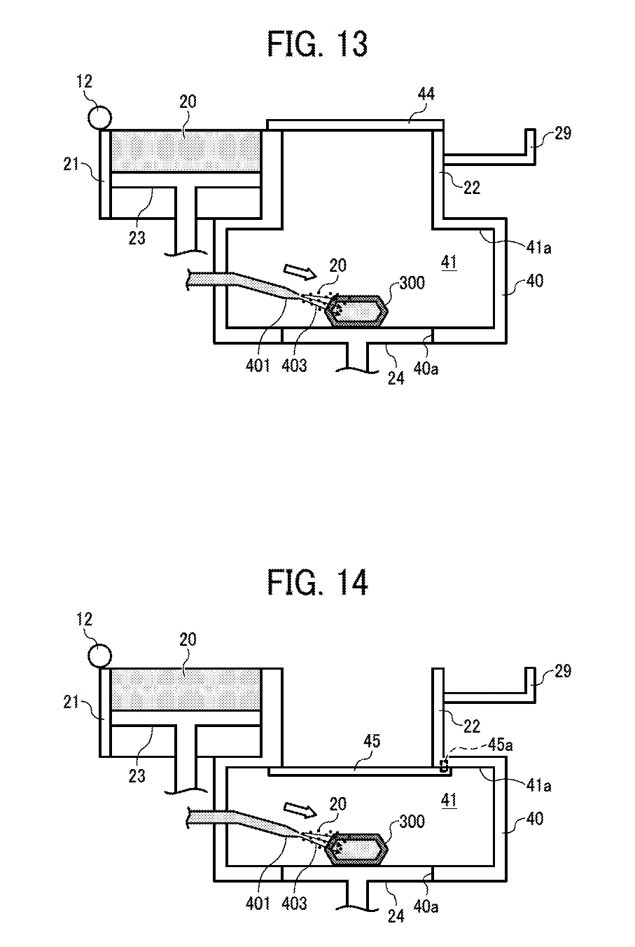

Next, a sixth embodiment of the present disclosure is described with reference to FIG. 13. FIG. 13 is a schematic view of the sixth embodiment.

In this embodiment, a cover 44 is disposed to open and close an opening of a fabrication chamber 22.

Such a configuration allows the opening of the fabrication chamber 22 to be closed with the cover 44 when unsolidified powder is removed after fabrication.

Accordingly, such a configuration reliably prevents powder 20 from being scattered around the powder removal device 400 when unsolidified powder is removed.

Further, the cover 44 may be transparent, thus securing visibility in removal work of unsolidified powder.

Next, a seventh embodiment of the present disclosure is described with reference to FIG. 14. FIG. 14 is a schematic view of the sixth embodiment.

In this embodiment, a partition 45 is disposed to open and close between the fabrication chamber 22 and the post-processing space 41. The partition 45 is rotatably supported with, for example, a shaft 45a.

Such a configuration also partitions between the fabrication chamber 22 and the post-processing space 41 with the partition 45 when unsolidified powder is removal, thus reliably preventing the powder 20 from being scattered around the device.

Further, the partition 45 may be transparent, thus securing visibility in removal work of unsolidified powder.

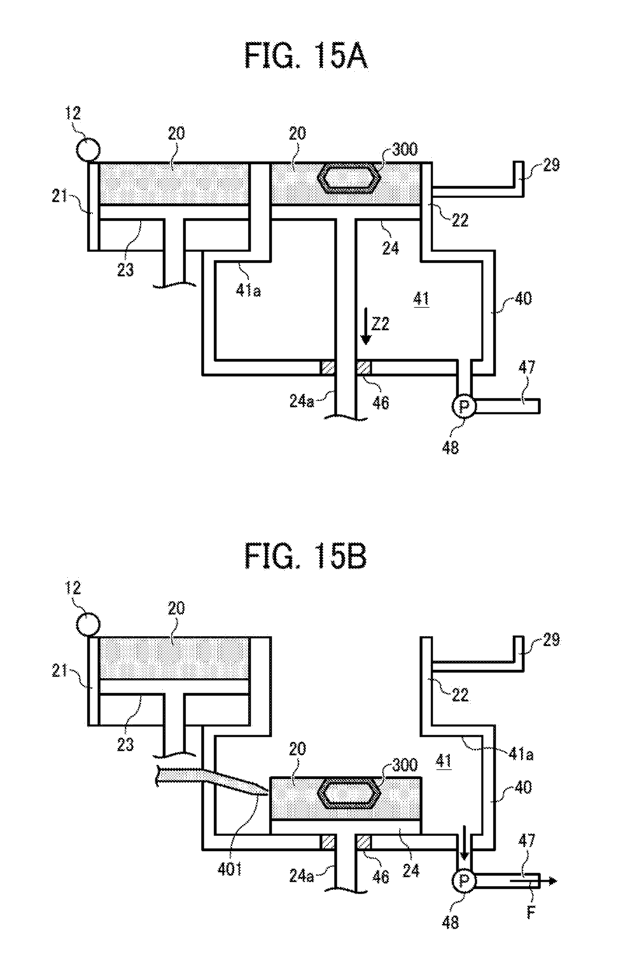

Next, an eighth embodiment of the present disclosure is described with reference to FIGS. 15A and 15B. FIGS. 15A and 15B are schematic views of the eighth embodiment.

In this embodiment, only a shaft 24a of the fabrication stage 24 passes through a bottom portion of the post-processing space formation member 40, and a seal 46 seals a clearance between the shaft 24a and the post-processing space formation member 40. The seal 46 is made of, for example, foamed polyurethane, thus allowing sealability and mobility.

Further, a powder collection passage 47 communicating with the post-processing space 41 is disposed and a pump 48 is disposed at the powder collection passage 47.

For such a configuration, after fabrication is finished as illustrated in FIG. 15A, the fabrication stage 24 is moved into the post-processing space 41 as illustrated in FIG. 15B. In FIG. 15B, the fabrication stage 24 is placed at a lowered position and in a state before an airflow is blown.

At this time, the seal 46 prevents unsolidified powder 20 from being discharged from a clearance between a bottom portion of the post-processing space 41 and the shaft 24a of the fabrication stage 24.

Then, an airflow is blown from the ejector 401 against the three-dimensional object 300 to remove unsolidified powder 20. At this time, the pump 48 is driven to generate an airflow indicated by arrow F in the powder collection passage 47, and powder 20 blown and removed from the three-dimensional object 300 is collected through the powder collection passage 47.

Note that the fabrication stage 24 and the post-processing space formation member 40 may be connected with an accordion member. Such a configuration also prevents unsolidified powder 20 from being discharged from the clearance between the bottom portion of the post-processing space 41 and the shaft 24a of the fabrication stage 24 while securing the mobility of the fabrication stage 24.

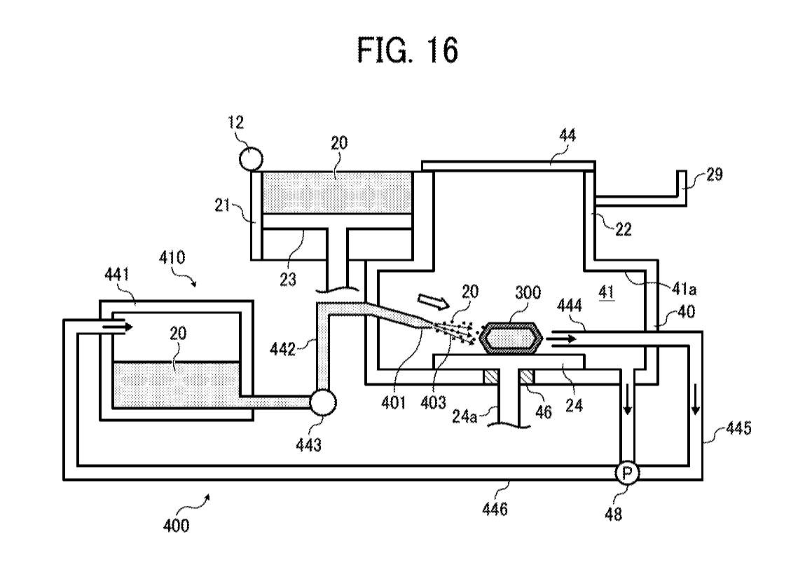

Next, a ninth embodiment of the present disclosure is described with reference to FIG. 16. FIG. 16 is a schematic view of the ninth embodiment.

In this embodiment, a reserve and collection tank 441 is disposed as a reservoir to reserve powder 20. The reserve and collection tank 441 and the ejector 401 is connected with a powder supply passage 442, and the powder 20 in the reserve and collection tank 441 is guided to the ejector 401 through the powder supply passage 442.

The powder supply passage 442 includes a pump 443 as an airflow generator to generate an airflow 403 including the powder 20 blown from a nozzle of the ejector 401.

Further, a powder removal device 400 according to the ninth embodiment further includes a suction unit (suction nozzle) 444 to suck powder 20 removed from a three-dimensional object 300. The suction unit 444 is placeable at a side opposite the ejector 401 via the three-dimensional object 300, in other words, at a side opposite a side of the three-dimensional object 300 against which the airflow 403 including the powder 20 is blown.

The suction unit 444 is coupled to the pump 48 via a powder collection passage 445. The pump 48 is coupled to the reserve and collection tank 441 via a powder collection passage 446.

For such a configuration, when unsolidified powder 20 is removed from the three-dimensional object 300, the powder 20 is supplied from the reserve and collection tank 441 to the ejector 401 with the pump 443 and jetted from the ejector 401. Further, the pump 48 is driven to suck and collect powder 20 through the powder collection passage 47 and the suction unit 444, and collected powder 20 is returned to the reserve and collection tank 441 through the powder collection passage 446.

When the three-dimensional object 300 has a penetration portion, such a configuration prevents unsolidified powder 20 or jetted powder 20 by the ejector 401 from being scattered, thus allowing effective circulation of the powder 20 jetted by the ejector 401. Further, the ejector 401 and the suction unit 444 is configured to be movable within the post-processing space 41, thus obtaining good workability.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A powder removal device comprising an air spray configured to blow an airflow including powder against a three-dimensional object including a plurality of fabrication layers, each fabrication layer including bonded powder, to remove unbonded powder from the three-dimensional object.

2. The powder removal device according to claim 1, wherein the air spray including:
an ejector configured to jet the airflow including the powder;
a reservoir configured to reserve the powder;
a powder supply passage connecting the reservoir to the ejector, to guide the powder from the reservoir to the ejector; and
a pump disposed at the powder supply passage, to generate the airflow jetted from the ejector.

3. The powder removal device according to claim 1, further comprising a suction unit configured to be placeable at a side opposite a side of the three-dimensional object against which the air spray blows the airflow,
wherein the suction unit is configured to suck the unbonded powder removed from the three-dimensional object.

4. The powder removal device according to claim 1, further comprising a suction unit to be placeable at a same side as a side of the three-dimensional object against which the air spray blows the airflow,
wherein the suction unit is configured to suck the powder rebounded from the three-dimensional object.

5. The powder removal device according to claim 1, wherein the air spray including:
an ejector configured to jet the airflow including the powder;
a powder supply passage connected to the ejector, to guide, to the ejector, a surplus of the powder generated in formation of the plurality of fabrication layers; and
a pump disposed at the powder supply passage, to generate the airflow jetted from the ejector.

6. The powder removal device according to claim 5, further comprising a suction unit to be placeable at a side opposite a side of the three-dimensional object against which the air spray blows the airflow,
wherein the suction unit is configured to suck the unbonded powder removed from the three-dimensional object.

7. The powder removal device according to claim 5, further comprising a suction unit to be placeable at a same side as a side of the three-dimensional object against which the air spray blows the airflow,
wherein the suction unit is configured to suck the powder rebounded from the three-dimensional object.

8. An apparatus for fabricating a three-dimensional object, the apparatus comprising the powder removal device according to claim 1.

9. An apparatus for fabricating a three-dimensional object, the apparatus comprising:
the powder removal device according to claim 1;
a fabrication chamber in which the three-dimensional object is to be fabricated; and
a fabrication stage on which the plurality of fabrication layers are to be laminated one on another, the fabrication stage movable upward and downward in the fabrication chamber,
the powder removal device including a post-processing space at a bottom side of the fabrication chamber, the post-processing space communicated with the fabrication chamber,
the fabrication stage movable downward from the fabrication chamber into the post-processing space,
the air spray configured to blow the airflow including the powder against the three-dimensional object on the fabrication stage.

10. The apparatus according to claim 9, further comprising a cover on the fabrication chamber to open and close an opening of the fabrication chamber.

11. The apparatus according to claim 9, further comprising a partition between the fabrication chamber and the post-processing space to open and close the fabrication chamber relative to the post-processing space.

12. A method of removing powder from a three-dimensional object, the method comprising blowing an airflow including the powder to the three-dimensional object including a plurality of fabrication layers, each fabrication layer including bonded powder, to remove unbonded powder from the three-dimensional object.
